(19) United States
(12) Patent Application Publication
(10) Pub. No.: US 2023/0157194 A1
(43) Pub. Date: May 25, 2023

(54) DEVICE FOR PLACING MATERIAL

(71) Applicants: John Strong, Eltopia, WA (US); Luke Strong, Eltopia, WA (US)

(72) Inventors: John Strong, Eltopia, WA (US); Luke Strong, Eltopia, WA (US)

(21) Appl. No.: 17/534,458

(22) Filed: Nov. 24, 2021

(51) Int. Cl. A01B 1/02

(52) U.S. Cl. CPC A01B 1/02

(57) ABSTRACT

A device for precisely placing material in a distant location comprising a scoop attached to a pole wherein the pole is at least five times the length of the scoop, the angle between the pole and the scoop is between 14 and 20 degrees, and the pole comprises multiple sections capable of being attached to one and another. The invention provides particular utility as a tool used in concrete leveling and smoothing.

### TECHNICAL FIELD

This invention relates generally to improvements in apparatus for placing material. Among other uses, the present invention may provide the capability to accurately place materials in locations that are difficult to reach.

### BACKGROUND OF THE INVENTION

There is a need for methods and apparatus to accurately place materials. For example, and not meant to be limiting, to create a level concrete surface, concrete is typically first placed inside of forms that define the outer perimeter of the slab. While the concrete is still in a “workable” state, meaning a fluid or semi-fluid state, a workman will engage in the process of “floating” or smoothing the concrete. During this process, it is frequently the case that a large slab will have a low spot that is not level with the remainder of the slab. To make the low spot level, it is often desirable to add additional concrete at that location. However, it is often the case that the low spot will be far from the edge of the slab, thereby preventing a workman from accurately placing material on the desired spot without putting weight on the slab, and potentially creating a new low spot that is not level with the remainder of the concrete.

There is therefore a need for improved methods and devices for placing materials in remote locations. Among other advantages, and not meant to be limiting, the present invention provides that capability.

### SUMMARY OF THE INVENTION

The present invention may include a device having a scoop attached to a pole for precisely placing material in a distant location. Preferably, but not meant to be limiting, the angle between the pole and the scoop is between 14 and 20 degrees, and is ideally 17 degrees.

The pole may comprise multiple sections capable of being attached to one and another.

The pole may be provided as at least five times the length of the scoop, and preferably at least twenty five time the length of the scoop.

The scoop may be provided as having an internal volume of at least 1 cup.

The scoop may also be provided as having a generally flat bottom.

### BRIEF DESCRIPTION OF THE DRAWINGS

The following detailed description of the embodiments of the invention will be more readily understood when taken in conjunction with the following drawing, wherein:

FIG. 1 is a perspective view of one embodiment of the apparatus of the present invention.

FIG. 2 is a side view of one embodiment of the apparatus of the present invention.

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitations of the inventive scope is thereby intended, as the scope of this invention should be evaluated with reference to the claims appended hereto. Alterations and further modifications in the illustrated devices, and such further applications of the principles of the invention as illustrated herein are contemplated as would normally occur to one skilled in the art to which the invention relates.

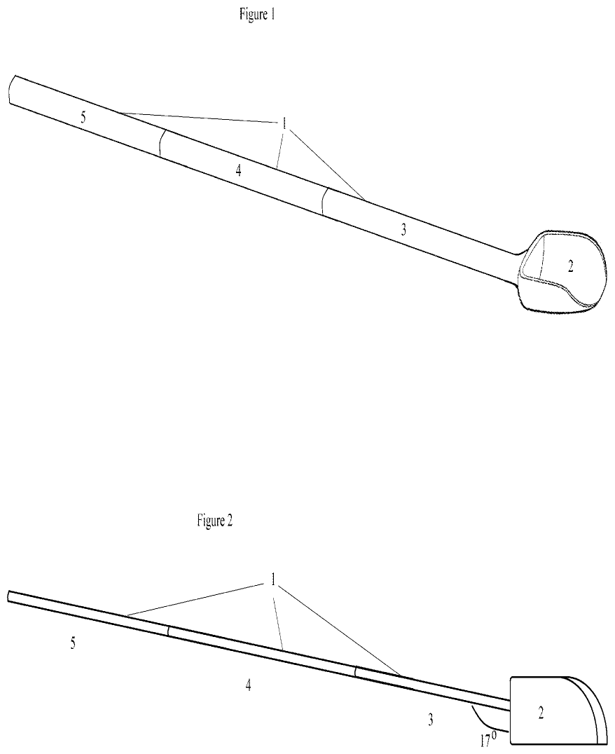

One exemplary embodiment of the present invention is shown in FIG. 1.

As shown in FIG. 1, the present invention may include a pole 1 attached to a scoop 2. As shown in FIG. 1, the pole 1 may include multiple sections 3, 4, and 5, capable of being attached to one and another. As also shown in FIG. 1, the pole 1 is at least five times the length of the scoop 2, and is preferably at least twenty five times the length of the scoop 2.

Preferably, but not meant to be limiting, the scoop 2 has an internal volume of at least 1 cup. As shown in FIG. 1, and also preferred, but not meant to be limiting, the scoop 2 has a generally flat bottom. While a curved bottom is also acceptable, it has been the inventor's experience that a flat bottom makes it easier for a workman to load the scoop 2.

As an example, and not meant to be limiting, it is often the case that when placing, leveling or smoothing a large concrete slab, a low spot will develop in the slab. Often, the low spot will be far away enough from the edge of the slab that a workman cannot place material on the low spot without walking, or otherwise putting their weight on, the slab, which in turn ruins the finish of the slab. The present invention allows a workman to accurately and quickly fill such low spot with material from a distance, thus allowing the workman to fill low spots far from the edge of the slab and provide a flat, level slab.

The concrete that is used to fill the low spot is often excess concrete that was placed on the ground, and not used to form the slab. When a workman uses the present invention to fill the scoop 2 with concrete, having too shallow of an angle between the pole 1 and the scoop 2 will often result in the scoop 2 digging into the concrete and hitting the ground beneath the excess concrete. This results in a mixture of dirt and concrete being placed in the scoop 2, which is undesirable because putting dirt in the slab will create a defect in the slab.

Conversely, having the scoop 2 at too steep of an angle can make it difficult to load the scoop 2 because it will glance off of the concrete.

FIG. 2 is an illustration showing he angle between the pole 1 and the scoop 2 at 17 degrees. While not meant to be limiting, the inventors have found that an angle of between 14 and 20 degrees is preferred, and an angle of 17 degrees is optimal for the operation of the present invention.

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding.

Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Finally, all publications, patents, and patent applications cited in this specification are herein incorporated by reference to the extent not inconsistent with the present disclosure as if each were specifically and individually indicated to be incorporated by reference and set forth in its entirety herein.

We claim:

1) A device for precisely placing material in a distant location comprising a scoop attached to a pole wherein the angle between the pole and the scoop is between 14 and 20 degrees.

2) The device of claim 1, wherein the pole comprises multiple sections capable of being attached to one and another.

3) The device of claim 1, wherein the pole is at least five times the length of the scoop.

4) The device of claim 1, wherein the scoop has an internal volume of at least 1 cup.

5) The device of claim 1, wherein the scoop has a generally flat bottom.

6) A device for precisely placing material in a distant location comprising a scoop attached to a pole wherein the pole comprises multiple sections capable of being attached to one and another.

7) The device of claim 6, wherein the angle between the pole and the scoop is between 14 and 20 degrees.

8) The device of claim 6, wherein the pole is at least five times the length of the bottom surface.

9) The device of claim 6, wherein the scoop has an internal volume of at least 1 cup.

10) The device of claim 6, wherein the scoop has a generally flat bottom.

11) A device for precisely placing material in a distant location comprising a scoop attached to a pole wherein the pole is at least five times the length of the scoop.

12) The device of claim 11, wherein the angle between the pole and the scoop is between 14 and 20 degrees.

13) The device of claim 11 wherein the pole comprises multiple sections capable of being attached to one and another.

14) The device of claim 11, wherein the scoop has an internal volume of at least 1 cup.

15) A device for precisely placing material in a distant location comprising a scoop attached to a pole wherein the pole is at least five times the length of the scoop, the angle between the pole and the scoop is between 14 and 20 degrees, and the pole comprises multiple sections capable of being attached to one and another.

16) The device of claim 15, wherein the scoop has an internal volume of at least 1 cup.
